(19) United States
(12) Patent Application Publication
(10) Pub. No.: US 2017/0193799 A1
(43) Pub. Date: Jul. 6, 2017

(54) Fall Protection Monitoring System

(71) Applicant: Douglas Raymond Holub, Crowder, OK (US)

(72) Inventor: Douglas Raymond Holub, Crowder, OK (US)

(21) Appl. No.: 15/393,184

(22) Filed: Dec. 28, 2016

Related U.S. Application Data
(60) Provisional application No. 62/275,166, filed on Jan. 5, 2016.

(51) Int. Cl. G08B 21/24; G08B 21/04; G08B 3/10; A62B 35/00; G06K 7/10

(52) U.S. Cl. CPC G08B 21/24; A62B 35/0006; A62B 35/0025; G06K 7/10366; G08B 3/10; G08B 21/043

(57) ABSTRACT

A fall protection monitoring system comprising motion sensors on safety hooks and on a safety harness. The system includes an electronic module which monitors the motion sensors and sounds an alarm when the movements of the safety hooks and the safety harness indicate that the safety hooks are not attached to anchorages while the person is climbing or moving around on an elevated structure. The electronic monitor module also logs the movements of the safety hooks and the safety harness for retrieval at a later time by the climber's supervisor, employer, or other interested persons.

### CROSS REFERENCE TO RELATED APPLICATION

This Non-provisional Patent Application claims priority to U.S. Provisional Patent Application No. 62/275,166 filed Jan. 5, 2016 which is incorporated herein in its entirety.

### FIELD OF THE INVENTION

This invention generally relates to a fall protection monitoring system. More particularly, this invention relates to a system that monitors the use of safety harnesses and safety hooks by climbers of elevated structures.

### BACKGROUND OF THE INVENTION

Steel workers, oil rig workers, communication and electrical power transmission workers among others are required to climb elevated structures such as electrical power transmission towers and other such elevated structures as part of their job. To ensure personal safety when aloft, a tower climber or any other elevated structure climber is required by the U.S. Occupational Safety and Health Administration (OSHA) to be tethered to some form of fall prevention equipment at all times when the climber is more than six feet above ground. This is called the “100% tie off” rule.

The correct safety equipment can prevent injury and death to climbers of elevated structures. The safety equipment used by climbers is generally a tether system which includes a safety harness, an anchorage point, and a connecting device. The safety harness is worn by the climber and may include a full body harness, a waist belt, or other such device. An anchorage point is a secure point of attachment for the connecting device on the elevated structure. The anchorage point must have sufficient strength to support the person climbing the structure, including the forces generated during a fall.

The connecting device is a lanyard or tether that connects the safety harness worn by the climber to the anchorage point. To ensure 100 percent fall protection, the lanyard most often used is a Y-lanyard. The Y-lanyard has three ends. The first end attaches to the safety harness, the second end attaches to a first safety hook, and the third end attaches to a second safety hook. As the climber moves, the second safety hook is attached to an anchorage point before the first safety hook is removed from an anchorage point. A safety hook often includes a safety gate mechanism which prevents the safety hook from slipping off its anchorage point. The safety hooks are heavy, and opening the safety gate requires squeezing the safety gate release lever with some force. As a result, some climbers choose not to use the safety hooks as they climb. According to OSHA, 359 construction workers fell to their death in the United States in 2014. The purpose of the present invention is to motivate and remind climbers to use the safety hooks as they climb, and so reduce the number of deaths and injuries which occur every year because climbers do not use their safety hooks.

U.S. Pat. No. 8,325053 to Flynt et al. describes a personal fall protection monitoring system which can detect when the safety hook is hanging on an anchorage point and when it is hanging on the climber's safety harness, and which can differentiate between these two states. This would often require sensors on the hook portion of the safety hook, the portion which is subject to physical abuse when in actual field use. In practice, the climber does not delicately move the safety hook from anchorage point to anchorage point. He more typically slams the hook onto the anchorage point without any regard for damage to the hook. Typical safety hooks are designed to withstand a maximum force of 5,000 pounds, so slamming them onto an anchorage point would normally not cause a problem. But it may be difficult to protect electronic sensors on the hook portion of the safety hook from these severe shocks. Further, detecting when the safety hook is hanging on the safety harness requires features incorporated into the safety harness which may make the safety harness more expensive and difficult to manufacture. U.S. Pat. Appl. Pub. No. 2013/0076515 by Flynt et al. claims sensors embedded in the safety harness which detect when the safety harness is properly buckled and when the climber is falling or has fallen.

The present invention overcomes the deficiencies in the prior art for fall protection monitoring systems. The exemplary features of the fall protection monitoring system of the present invention will become obvious to one skilled in the art through the summary of the invention, detailed description of the invention, and the claims that follow.

### SUMMARY OF THE INVENTION

It is an object of the present invention to provide an improved personal fall protection monitoring system that addresses the deficiencies in the prior art for such systems so that workers who climb elevated structures such as communication and electrical towers and other such structures are able to avail themselves of a less expensive, more robust personal fall protection monitoring system.

It is a further object of the present invention to provide a low cost personal fall protection monitoring system that can be effectively used with existing safety harnesses in the field, thereby eliminating the need for users to purchase new safety harnesses or retrofit old safety harnesses, as would be required with the systems disclosed in U.S. Pat. No. 8,325,053 and in U.S. Pat. Appl. Pub. No. 2013/0076515.

In an exemplary embodiment of the fall protection monitoring system of the present invention, the system monitors both the altitude of the safety harness worn by a climber as well as the operation of the safety gate release lever on the safety hook. This information is logged electronically by the monitoring system and stored for later retrieval by supervisors, employers, insurance companies, or other interested parties. If the monitoring system determines that the climber is not employing the safety hook as he climbs, an alarm sounds to remind the climber to use the safety hook. The logging of the climber's altitudes and safety gate release lever operations serves to motivate the climber to use his safety hook in order to avoid a reprimand from his supervisor or employer for not complying with company safety policy. In this embodiment of the invention, the sensor which monitors the altitude of the safety harness is attached to the lanyard near the place where the lanyard attaches to the safety harness, and all other monitor components are attached to either the lanyard or to the safety hook. This has the advantage of adding no expense to the safety harness itself, and also allows lanyards in this embodiment to be used with existing safety harnesses in the field.

In one embodiment, the fall protection monitoring system of the present invention includes three pressure sensors (altimeters) attached to a Y lanyard. The first sensor is attached near the safety harness attachment point, the second sensor is attached near the first safety hook, and the third sensor is attached near the second safety hook. A monitor logs the altitudes of the three sensors, and compares the altitude of each safety hook to the altitude of the safety harness. If the monitor detects that the changes in altitudes of these three sensors are not consistent with the changes expected when a climber is complying with the 100% tie off rule, an alarm would sound. For example, if the altitude sensors indicate that both safety hooks and the safety harness are simultaneously increasing in altitude at the same rate, the monitor would conclude that both safety hooks were attached to the safety harness instead of to an anchorage point, and the monitor would sound an alarm. This embodiment requires no modifications to existing safety hooks, thereby avoiding tooling costs and the expensive qualification testing required for new safety hook designs. In this embodiment, the monitor, sensors, and wiring are all installed inside the tubular fabric lanyard straps. This serves to protect the monitoring system from the physical abuse which this type of safety equipment often receives.

In yet another embodiment of the fall protection monitoring system of the present invention, the system includes a single leg lanyard. In this embodiment, a sensor detects when the safety gate release lever moves so that the hook's safety gate can open. In this embodiment, one of the sensors is a simple electromechanical switch mounted away from the hook portion of the safety hook. A second sensor detects the acceleration of the safety harness. The monitoring system calculates the speed, direction, and position of the safety harness from the acceleration data, and also detects the operation of the safety gate release lever. An alarm sounds when the safety harness position and safety gate release lever activity indicate that the climber is not attaching the safety hook to an anchorage point as he climbs or moves around on an elevated structure. For example, if the safety harness accelerometer indicates that the harness has moved more than twice the length of the lanyard in any one direction while there were no safety gate release lever operations, the monitor would conclude that the safety hook was not attached to an anchorage point as the climber moved, and would sound an alarm.

In this summary of the present invention describing the objects and embodiments of the invention and in the specification in general, references to “the exemplary embodiment”, or “yet another embodiment” do not necessarily all refer to the same embodiment(s). Rather, the references to the various embodiments mean that a particular feature, structure, or characteristic described in conjunction with a specific embodiment is included in at least some embodiments, but not necessarily all embodiments of the invention. The objects, embodiments, and features of the fall protection monitoring system of the present invention as described in this summary of the invention will be further appreciated and will become obvious to one skilled in the art when viewed in conjunction with the drawings, detailed description of the invention, and the appended claims.

### BRIEF DESCRIPTION OF THE DRAWINGS

FIG. 1 is a perspective view of a person climbing a ladder while wearing a full body safety harness.

FIG. 2 is a perspective view of a typical safety hook.

FIG. 3 is a perspective view of a single leg lanyard used in one embodiment of the present invention.

FIG. 4 is a perspective view of a Y-lanyard used in another embodiment of the present invention.

FIG. 5 is a block diagram of one embodiment of a personal fall protection monitoring system.

FIG. 6 is a flow chart describing one embodiment of a personal fall protection monitoring software program.

### DETAILED DESCRIPTION OF THE INVENTION

The present invention is a fall protection monitoring system that monitors the use of safety harnesses and safety hooks by climbers of elevated structures. The system is able to be used with existing safety harnesses so that the cost of employing the system is kept to a minimum.

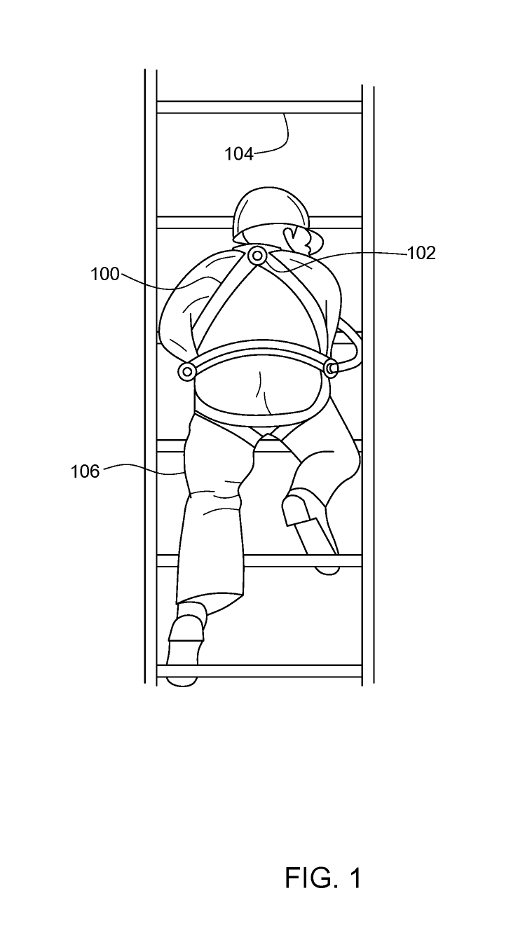

Referring now to the figures wherein like numerals represent like components in the several views presented and discussed, and more particularly referring now to FIG. 1, the figure is a perspective view of a person climbing a ladder while wearing a full body safety harness. The climber 106 who is typically a steel worker, oil rigger, or a communications and/or electrical tower maintenance worker performs their tasks by ascending, descending and moving from point-to-point on the respective elevated structures. The climber 106 is wearing a safety harness 100 which can be secured to anchorages on a ladder 104 by a lanyard connected to the safety harness through a lanyard attachment ring 102 on the safety harness 100.

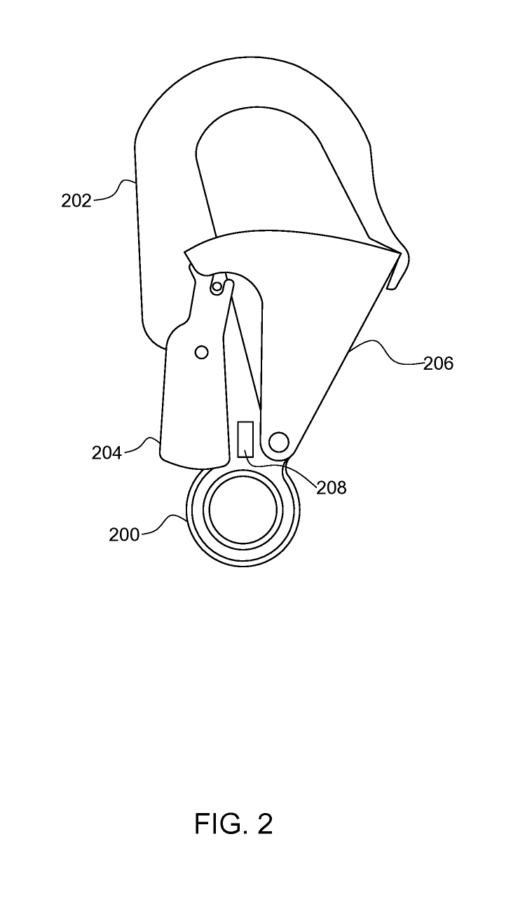

FIG. 2 illustrates the configuration of a typical safety hook 200 used in the monitoring system. The safety hook 200 consists of a hook portion 202, a safety gate 206, and a safety gate release lever 204. The safety gate 206 serves to prevent the safety hook 200 from slipping of its anchorage 104 such as a ladder shown in FIG. 1. The safety gate 206 must open in order for the safety hook 200 to be attached to or to be released from the anchorage 104. The safety gate release lever 204 prevents the safety gate 206 from opening. Squeezing the safety gate release lever 204 allows the safety gate 206 to open. This figure illustrating the features of the safety hook 200 also shows the positioning of the safety hook motion sensor 208. The safety hook motion sensor 208 could be an accelerometer or an altimeter. In an embodiment in which only the motion of the safety gate release lever 204 is detected, the safety hook motion sensor 208 could be a simple electromechanical switch.

The type of lanyard and fall arrestors used by a climber depends on the work to be performed and the type of structure being climbed. There are primarily two lanyard configurations, a single leg lanyard and a dual leg lanyard, or Y-lanyard. Both configurations typically attach to the safety harness 100 at a point near the top of the safety harness 100 on the back of the climber 106. Both the single leg lanyard and the Y-lanyard are often configured to attach to the lanyard attachment ring 102 of the safety harness 100 by means of a safety harness hook 304. Some lanyards are permanently attached to the safety harness using rivets, thread, or other mechanical means.

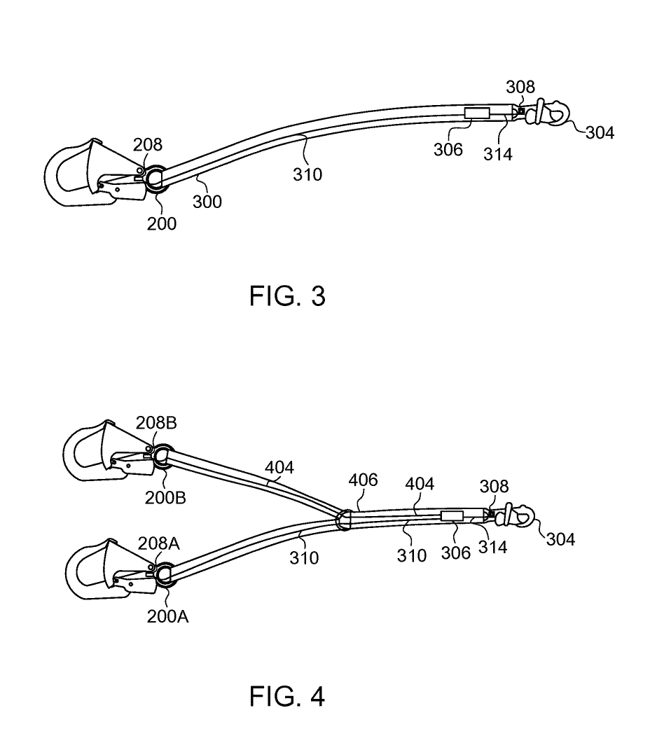

FIG. 3 is a perspective view of a single leg lanyard 300 used in one embodiment of the fall prevention monitoring system of the present invention. In this embodiment of the invention, a monitor electronics module 306 is attached to the single leg lanyard 300. A safety harness hook motion sensor 308 is attached to the safety harness hook 304. The sensor 308 could also be attached to the single leg lanyard 300 near the safety harness hook 304. A safety hook motion sensor 208 is attached to the safety hook 200 at the other end of the single leg lanyard 300. The safety hook motion sensor 208 could be a simple electromechanical switch attached to the safety hook 200 at a place where the switch would only be activated when the safety gate release lever 204 had moved sufficiently to allow the safety gate 206 to open. A wire 310 connects the safety hook motion sensor 208 to the monitor electronics module 306. Another wire 314 connects the safety harness hook motion sensor 308 to the monitor electronics module 306.

The safety harness hook motion sensor 308 could be a 3-axis accelerometer such as the MMA8653FCR1 manufactured by Freescale Semiconductors. It is smaller than a dime and sells for less than one dollar. The advantage of a 3-axis accelerometer is that movements can be detected in any direction. The safety harness hook motion sensor 308 could also be a pressure sensor, or altimeter, such as the LPS331AP manufactured by ST Microelectronics. It is accurate to within 15 cm of altitude, is smaller than a dime, and sells for about two dollars. Using an altimeter without an accelerometer would limit measurements to ascending and descending movements only.

FIG. 4 is a perspective view of a Y lanyard 406 used in another embodiment of the present invention. In this embodiment, a first safety hook motion sensor 208A is attached to a first safety hook 200A and a second safety hook motion sensor 208B is attached to a second safety hook 200B on the Y-lanyard 406. A safety harness hook motion sensor 308 is attached to the opposite end of the Y-lanyard 406 near the safety harness hook 304. The three sensors, 208A, 208B, and 308 could be mounted on their respective hooks on the Y-lanyard 406 as illustrated in this figure or they could be attached to the Y-lanyard 406 at locations very near each of the three hooks so that the motions of the sensors attached to the ends of the three Y-lanyard 406 straps are very similar to the motions of the three hooks attached to the Y-lanyard 406. The advantage of mounting the sensors to the Y-lanyard 406 instead of to the safety hooks 200A, 200B or to the safety harness hook 304 is that all of the monitor system components and wiring could be contained in the Y-lanyard 406. This would make integrating the monitoring system with existing safety hooks 200A, 200B and safety harness hooks 304 possible without any concern for exposed discrete wires 310, 404, and 314 at the points where the lanyard straps attach to the respective hooks.

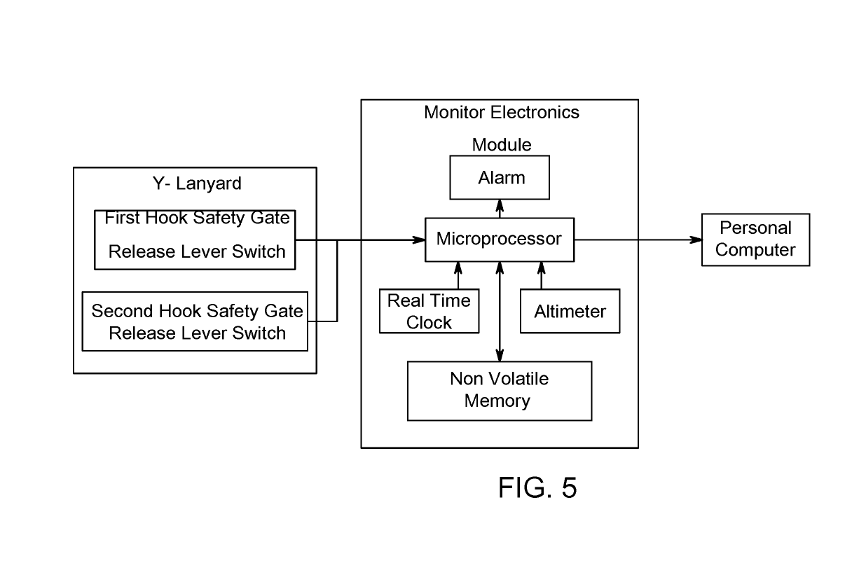

FIG. 5 is a block diagram of an embodiment of a personal fall protection monitor system. A microprocessor receives signals from two electromechanical switches. Each switch is mounted to a safety hook 200 in a location which causes the switch to close when the safety gate release lever 204 has moved sufficiently to allow the safety gate 206 to open. The microprocessor is included in a monitor electronics module which is attached to a Y-lanyard 406. The monitor electronics module also includes a real time clock, an altimeter, non-volatile memory, and an audible alarm such as a piezo electric buzzer. The microprocessor uses the information from the real time clock to time and date stamp the information which it logs into the non-volatile memory. The microprocessor receives altitude information from the altimeter. When a software algorithm in the microprocessor determines that the movements of the safety gate release levers 204 and the changes in altitude measured by the altimeter are not consistent with the movements and changes expected from a climber 106 who is attaching his safety hooks 200 to anchorages 104, the microprocessor causes the audible alarm to sound. The microprocessor logs time, date, altitude, and safety gate release lever signal information into the non-volatile memory. This information can be sent to an external device such as a personal computer or a smart phone to be viewed by the climber's 106 supervisor, employer, or other interested persons.

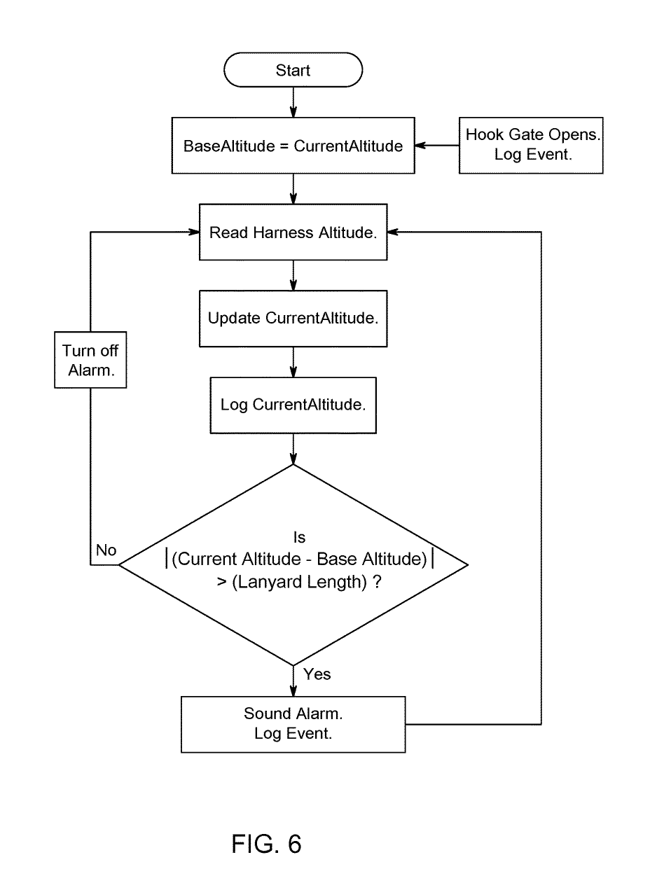

FIG. 6 is a flow chart of an embodiment of a software algorithm which could be used by a microprocessor to monitor personal fall protection equipment. In this embodiment, the algorithm begins by causing a variable called BaseAltitude to be initialized to the same value as a variable called CurrentAltitude. The value of CurrentAltitude is the actual altitude of the pressure sensor (altimeter) which is attached to a safety harness hook 304. Any time a signal is received by the microprocessor indicating that the safety gate release lever 204 has moved sufficiently to allow the safety gate 206 to open, BaseAltitude is again initialized to the value of CurrentAltitude. The microprocessor reads the current altitude from the altimeter periodically, stores that value in the variable CurrentAltitude, and logs that altitude information into non-volatile memory. After every altitude measurement, the microprocessor calculates the absolute value of the difference between CurrentAltitude and BaseAltitude, and compares it to twice the length of the single leg lanyard 300. If the difference in altitude is greater than twice the length of the single leg lanyard 300, the microprocessor activates an audible alarm, logs the alarm condition into the non-volatile memory, and returns to perform another altitude measurement and calculation loop.

The foregoing description of the invention through its figures and preferred embodiments should not be construed to limit the scope of the invention. It is to be understood that the embodiments of the present invention as described herein do not limit any application or scope of the invention and that the invention can be carried out and practiced in various ways and implemented in embodiments other than the ones outlined in the description above. It is to be further understood that the phraseology and terminology used to describe the invention are for descriptive purposes only. It should be understood and obvious to one skilled in the art that alternatives, modifications, and variations of the embodiments of the present invention may be construed as being within the spirit and scope of the appended claims. For example, the motion sensors could be global positioning satellite (GPS) sensors, laser measuring equipment, radar distance measuring devices, or radio frequency identification (RFID) sensors, among others. The switch which detects the motion of the safety gate release lever could instead detect the opening of the safety gate itself. The safety harness could be a simple belt or safety vest. Safety hooks are currently available in a variety of shapes, with a variety of safety gate and safety gate release lever designs, many of which could be configured to work with an embodiment of the present invention. Instead of a simple switch to detect the motion of the safety gate release lever, an accelerometer could be attached directly to the safety gate release lever and a second accelerometer could be attached to the safety hook itself. The difference in motion of the safety gate release lever and the safety hook would indicate when the safety gate release lever had moved sufficiently to allow the safety gate to open.

What is claimed is:

1. An apparatus for a fall protection monitoring system comprising:
a. a safety harness for use by a climber,
b. a safety hook having a hook portion, a safety gate, and a safety gate release lever,
c. said safety hook configured to receive an anchor through said hook portion when said safety gate is opened by means of operating said safety gate release lever,
d. said safety hook having a first sensor, said first sensor detecting the motion of said safety gate release lever,
e. a lanyard of predetermined length having a first end attached to said safety hook, and a second end attached to said safety harness,
f. a monitor electronics module in communication with said first sensor, said monitor configured to attach to said lanyard,
g. said monitor in communication with a second sensor, said second sensor detecting the motion of said safety harness,
h. said monitor responsive to a first signal from said first sensor and to a second signal from said second sensor, and
i. said monitor configured to record and save said first signal and said second signal for later retrieval.

2. The apparatus of claim 1 wherein the monitor electronics module is attached to the safety harness.

3. The apparatus of claim 1 further including an output signal from the monitor electronics module, said output signal indicating when the safety gate release lever of the safety hook has not moved sufficiently to allow the safety gate to open during a time in which the safety harness has moved further than twice the length of the lanyard.

4. The apparatus of claim 3 further including an audible alarm which is activated by said output signal.

5. An apparatus for a fall protection monitoring system comprising:
a. a safety harness for use by a climber,
b. a lanyard of predetermined length having a first end attached to a safety hook and a second end attached to said safety harness,
c. a first sensor attached to said safety hook, said first sensor detecting the motion of said safety hook,
d. a second sensor attached to said safety harness, said second sensor detecting the motion of said safety harness,
e. a monitor electronics module, said monitor in communication with said first sensor and said second sensor,
f. said monitor responsive to a first signal from said first sensor and to a second signal from said second sensor, and
g. said monitor configured to record and save said first signal and said second signal for later retrieval.

6. The apparatus of claim 5 wherein the first sensor is attached near the first end of said lanyard.

7. The apparatus of claim 5 wherein the second sensor is attached near the second end of said lanyard,

8. The apparatus of claim 5 wherein the first sensor is attached near the first end of said lanyard, and the second sensor is attached near the second end of said lanyard.

9. The apparatus of claim 5 further including an output signal from said monitor electronics module, said output signal being active when the monitor detects the condition in which the safety harness and the safety hook are moving in the same or nearly the same direction at the same or nearly the same rate simultaneously or nearly simultaneously.

10. The apparatus of claim 9 further including an audible alarm which is activated by said output signal.

11. A method for monitoring the use of a safety hook while a person wearing a safety harness climbs or moves on an elevated structure, comprising:
a. sensing the motion of said safety hook;
b. sensing the motion of said safety harness; and
c. logging the motion of said safety hook and the motion of said safety harness for later retrieval.

12. The method of claim 11 further including sounding an alarm when the safety harness and the safety hook are sensed to be moving in the same or nearly the same direction at the same or nearly the same rate simultaneously or nearly simultaneously.
